(19) United States
(12) Patent Application Publication
(10) Pub. No.: US 2006/0093111 A1
(43) Pub. Date: May 4, 2006

(54) Method for charge-back on unwanted solicitations

(76) Inventor: Michael C. Peck, Hayward, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/979,972

(22) Filed: Nov. 2, 2004

(51) Int. Cl. H04M 15/00

(52) U.S. Cl. 379/114.13

(57) ABSTRACT

A method enabling a solicitee of an unwanted solicitation to cause a solicitor of the unwanted solicitation to provide compensation for said unwanted solicitation to the solicitee. The method steps include directing the unwanted solicitation to the solicitee via a carrier, considering the unwanted solicitation by the solicitee, rejecting the unwanted solicitation, invoicing the solicitor and compensating the solicitee and the carrier.

### INCORPORATION BY REFERENCE

Applicant(s) hereby incorporate herein by reference, any and all U.S. patents and U.S. patent applications cited or referred to in this application, as filed.

### BACKGROUND OF THE INVENTION

1. Field of the Invention

This invention relates generally to methods of soliciting goods and services to the general public and further to methods of compensating the general public for their time and efforts in dealing with such solicitations when they are unwanted.

2. Description of Related Art

The following art defines the present state of this field:

Council, U.S. Pat. No. 6,192,114 describes a method and apparatus for determining whether a party sending an email communication is on a list of parties authorized by the intended receiving party. If the sending party is not on the list of authorized parties, a fee is charged to the sending party in return for the message being provided to the intended receiving party, or if the sending party has not authorized such fees to be charged, the message is simply discarded. Preferably, the present invention is implemented with Internet communications. However, the present invention can be used in private networks as well, such as local area networks (LANs) and wide area networks (WANs). Preferably, the present invention is implemented at the intended receiving party's IEP. In accordance with the well-known Transmission Control Protocol/internet Protocol (TCP/IP), the destination address of the intended receiving party and the source address the sending party are contained in the IP message, commonly referred to as a datagram. When a datagram is received at the IEP, the IEP server analyzes the destination address and the source address to determine whether the source address is on a list of authorized source addresses associated with the destination address.

Council et al., U.S. Pat. No. 6,587,550 describes a method and apparatus for determining whether a party sending an email communication is on a list of parties authorized by the intended receiving party. If the sending party is not on the list of authorized parties, an electronic billing agreement is emailed to the sending party indicating a fee that will be charged to the sending party in return for the message being provided to the intended receiving party. Preferably, the present invention is implemented with Internet communications and utilizes a security protocol to enable the electronic transaction to be transacted in a secure manner.

Raymond, U.S. Pat. No. 6,697,462 describes a system and method for discouraging unwanted electronic communications requiring a communication sender who is not recognized by the intended recipient, or who is not approved by the intended recipient, to a post a bond to accompany the communication. Adaptable to eliminating spam, unwanted faxes, unwanted telephone calls, etc., the system and method forces the money associated with the bond to be forfeited if the communication is rejected or deemed undesirable by the recipient. To prevent financially motivated abuse on the part of recipients, the preferred embodiment forfeits the bond money in favor of a third party such as a charity or governmental entity, to which the recipient has no legal obligation. A further safeguard against recipient abuse gives senders a predetermined number of unsolicited communications to send to system subscribers, after which bonds are required to send unapproved communications.

CBT Flint Partnership, WO 00/10318 describes a method and apparatus for determining whether a party initiating a telephone call is authorized by the recipient party to communicate with the recipient party. If the calling party is not authorized, a fee may be charged to the calling party in order for communication to the recipient party to continue. Processing equipment located at the subscriber's central office is programmed to determine the identity of the calling party and determine if the calling party is an authorized party to the communication recipient. This is done by comparing the calling parties identity or telephone number to a pre-programmed list of authorized calling parties associated with the called parties identifier or telephone number.

Our prior art search with abstracts described above teaches a method and apparatus for billing a fee to a party initiating an electronic mail communication when the party is not on an authorized list associated with the party to whom the communication is directed (Council); a system and method for discouraging communications considered undesirable by recipients (Raymond); and a method and apparatus for determining whether a fee is to be charged to a party initiating a telephone call (Santos PCT). However, the prior art fails to teach the utilization of simple rejection actions by a receiver of unwanted solicitations without the need for bond posting or for access through lists and such. The present invention fulfills these needs and provides further related advantages as described in the following summary.

### SUMMARY OF THE INVENTION

The present invention teaches certain benefits in a method that gives rise to the objectives described below.

In most of the industrialized world, individuals, organizations and business firms are eager to solicit their ideas, services and products to the general public and to specific segments of the public, commercial enterprises and government for financial, political, and social gain and for many other reasons. We shall speak of these acts as solicitations, with the originator of the solicitation as the solicitor, the target of the solicitation as the solicitee and the carrier of the solicitation, referred to herein as the carrier. Advertising is found, generally everywhere including on television, radio, newspapers, magazines, trade journals and many other venues. More targeted advertising consists of solicitations to individuals by telephone, email and United States mail. In particular, telephone, email and mail solicitations are personally intrusive and ways and means for avoiding them are constantly sought. The present invention defines a method for potentially controlling such personal solicitations.

In a best mode preferred embodiment of the present invention, a method enables a solicitee of an unwanted solicitation to cause a solicitor of the unwanted solicitation to provide compensation to the solicitee. The method comprises the steps of: directing the unwanted solicitation to the solicitee through a carrier; considering the unwanted solicitation; rejecting the unwanted solicitation; invoicing the solicitor; and compensating the solicitee and the carrier.

A primary objective of one embodiment of the present invention is to provide an apparatus and method of use of such apparatus that yields advantages not taught by the prior art.

Another objective is to assure that an embodiment of the invention is capable of compensating a solicitee for being the recipient of unwanted mail, email and phone calls.

A further objective is to assure that an embodiment of the invention is capable of compensating the solicitee without discourse between solicitor and solicitee.

A still further objective is to assure that an embodiment of the invention is capable of compensating those that deliver solicitations for their efforts in compensating solicitees.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

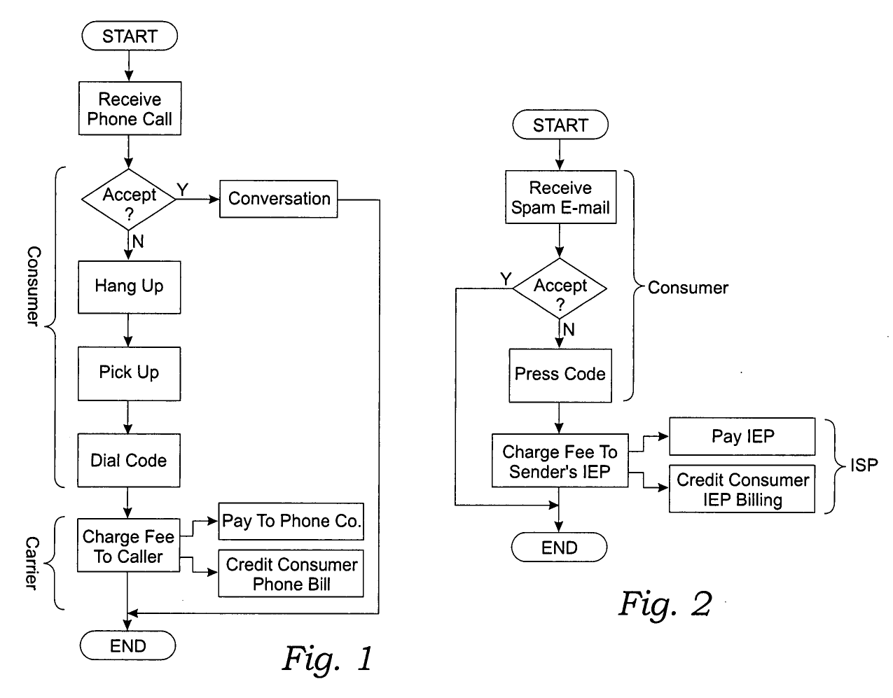

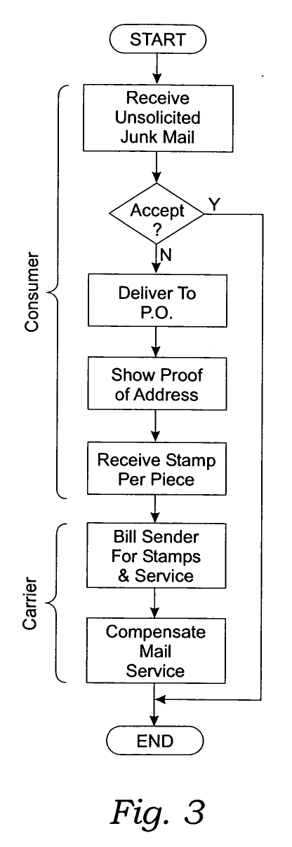

The accompanying drawings illustrate several best mode embodiments of the present invention. In such drawings FIGS. 1-3 are logic flow charts of three embodiments of the present invention method.

### DETAILED DESCRIPTION OF THE INVENTION

The above-described drawing figures illustrate the present invention in at least one of its preferred, best mode embodiments, which are further, defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

In one aspect of a best mode embodiments of the present invention the method enables a solicitee of an unwanted solicitation, to cause a solicitor, the person or organization that causes the solicitation to be originated, and who generally has the most to gain when such a solicitation achieves its objective, i.e., a sale, for instance, to provide compensation to the solicitee. Such compensation may be financial or otherwise, as will be explained in this disclosure. The method includes directing an unwanted solicitation to a solicitee who then considers the unwanted solicitation, and generally does not have the possibility of not considering it since it is directed in such a manner that it cannot be avoided. For instance, the solicitation, may be a phone call arriving at the phone of the solicitee, an email message that arrives in the solicitee's computer e-mail box, or a piece of mail that arrives in the solicitee's United States post mail box. The method further includes the step of actively rejecting the unwanted solicitation and this causes the solicitor to be invoiced and the solicitee to receive compensation as will be described below.

In one of the best mode embodiments of the present invention, the unwanted solicitation is directed to the solicitee over a telephone network, i.e. the carrier. The unwanted solicitation is considered when the solicitee hears the solicitation. The unwanted solicitation may be rejected by the solicitee by hanging-up the telephone. The rejection is further established when the solicitee dials a numeric code sequence, and this would occur prior to any further incoming or outgoing calls from the same phone. An automated protocol associates the code sequence with the last incoming number. The code sequence, similar to the 69 callback, is programmed to identify the caller and send a data message to the phone network service that the call was rejected as an unwanted call. The phone network service organization then takes action to invoice the solicitor by placing a debit amount on the solicitor's phone service accounting. This debit appears on the solicitor's monthly billing at the next billing opportunity. The solicitee is compensated in the same way by placing a credit on the solicitee's phone service accounting. The phone service organization is compensated for their billing procedures by sharing in the amount debited to the solicitor. For instance, if the solicitor is debited one dollar for each unwanted phone call, the solicitee may be credited an amount equal to one-half, or fifty cents, while the phone service receives the other one-half. The net result of this billing of the solicitor for each unwanted solicitation is that the quality of such solicitations will improve and the volume will diminish. The general public will benefit by fewer interruptions and by receiving more highly targeted solicitations and solicitations of greater value.

In another one of the best mode embodiments of the present invention, the unwanted solicitation is directed to the solicitee as email. The unwanted solicitation is considered by the solicitee when he/she observes the solicitation on a computer monitor with the solicitation (SPAM) residing among all other incoming email messages. In that SPAM is most often configured and disguised as an ordinary message, the solicitee is tricked into opening the message only to find that it is an undesired unwanted solicitation. The message is rejected by moving the unwanted solicitation to a SPAM folder as is well known in the art, and then by pressing a numeric code sequence. The solicitee's Internet email provider (IEP) is then set into action to invoice the solicitor by placing a debit on the solicitor's Internet email provider account. Of course this will require cooperation between such IEPs. The solicitee is compensated by placing a credit on the solicitee's service accounting, perhaps on the order of five cents, and, as in the above case with the telephone protocol, the IEP receives compensation as well, again by perhaps five cents. The net result of this billing of the solicitor for each unwanted solicitation is that the quality of such solicitations will improve and the volume will diminish. The general public will benefit by fewer interruptions and by receiving more highly targeted solicitations and solicitations of greater value.

In another one of the best mode embodiments of the present invention, the unwanted solicitation is directed to the solicitee by a mail delivery service, and in particular, the United States Post Office service; the carrier. The unwanted solicitation is delivered to the solicitee's address by, for instance, a mail carrier. It is considered by observing the physical mail piece in the solicitee's mailbox. This is a common occurrence that most of the general public has experienced many times. The unwanted solicitation is rejected by not using the mail piece, although due to mail that is disguised as important papers when observing the exterior of the parcel, the solicitee may open the parcel only to find that it is not what is expected, but rather an unwanted unwanted solicitation. The rejection further is made clear by returning the mail piece to the mail delivery service, i.e., the post office. The unwanted solicitation is invoiced to the solicitor by placing a debit on the solicitor's mail delivery service accounting. Since most large-scale mail solicitations are sent by bulk mail methods, and such bulk mail users have a unique mail code related to a Post Office account, such debiting of the solicitors can be a routine matter. The solicitee is compensated by placing a credit on the solicitee's mail delivery service accounting or by dispensing a postage stamp to the solicitee for each mail piece returned to the Post Office. The net result of this billing of the solicitor for each unwanted solicitation is that the quality of such solicitations will improve and the volume will diminish. The general public will benefit by fewer interruptions and by receiving more highly targeted solicitations and solicitations of greater value. The Post Office will benefit by a significant reduction in mail volume, and arguably without a drop in revenue since the Post Office will benefit from the debiting process in compensation for loss of volume. Finally, the solicitors will benefit from notification of unwanted, or bad, listings giving them the opportunity, and incentive, to to update and improve their lists for improved targeting at lower overall cost.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method enabling a solicitee of an unwanted solicitation to cause a solicitor of the unwanted solicitation to provide compensation for said unwanted solicitation to the solicitee, the method comprising the steps of: directing the unwanted solicitation to the solicitee by a third party carrier; considering the unwanted solicitation by the solicitee; rejecting the unwanted solicitation by the solicitee to the carrier; invoicing the solicitor by the carrier; and compensating the solicitee and the carrier by the solicitor.

2. The method of claim 1 wherein the directing is via a telephone network, and wherein the considering is by hearing the solicitation over the telephone network, and the rejecting is by breaking a telephone connection, and by dialing a numeric code sequence, and the invoicing is by placing a debit on the solicitor's phone service accounting; and the compensating is by placing a credit on the solicitee's phone service accounting.

3. The method of claim 1 wherein the directing is by an email service as an email message, and the considering is by observing the email message on a computer monitor, and the rejecting is by moving the unwanted solicitation to a SPAM folder, and by generating a numeric code sequence, and the invoicing is by placing a debit on the solicitor's email service accounting; and the compensating is by placing a credit on the solicitee's email service accounting.

4. The method of claim 1 wherein the directing is by a mail delivery service as a letter or package, and the considering is by observing the letter or package, and the rejecting is by returning the mail piece to the mail delivery service, and the invoicing is by placing a debit on the solicitor's mail delivery service accounting; and the compensating is by giving the solicitee a first class stamp for each returned letter or package.

5. The method of claim 4 wherein the mail delivery service is the U.S. Postal Service.
